(19) United States
(12) Patent Application Publication
(10) Pub. No.: US 2013/0132851 A1
(43) Pub. Date: May 23, 2013

(54) SENTIMENT ESTIMATION OF WEB BROWSING USER

(71) Applicants: David Konopniki, Haifa (IL); Haggai Roitman, Elit (IL); Michal Shmueli-Scheuer, Ramat-Gan (IL); Benjamin Sznajder, Jerusalem (IL)

(72) Inventors: David Konopniki, Haifa (IL); Haggai Roitman, Elit (IL); Michal Shmueli-Scheuer, Ramat-Gan (IL); Benjamin Sznajder, Jerusalem (IL)

(73) Assignee: INTERNATIONAL BUSINESS MACHINES CORPORATION, Armonk, NY (US)

(21) Appl. No.: 13/301,818

(22) Filed: Nov. 22, 2011

(51) Int. Cl. G06F 15/177

(52) U.S. Cl. 715/736

(57) ABSTRACT

Method, system, and computer program product are provided for sentiment estimation of a web browsing user. The method includes: estimating for pages of a website a sentiment based on background content; receiving a path of pages browsed by a user to a current page; and estimating the user's sentiment to a current page based on the path taken to the current page and the sentiments based on the background content of the visited pages. The method may also include dynamically changing website content provided to the user based on the user's estimated sentiment to a current page.

### BACKGROUND

This invention relates to the field of analysis of web browsing. In particular, the invention relates to sentiment estimation of a web browsing user.

Sentiment analysis provides means for estimating the various sentiments a community or an individual have towards some topic. For example, sentiment analysis can be used to determine the positive or negative attitude some population has for a given brand or product.

Sentiment analysis is commonly applied on explicit user generated content (UGC) contributed by various users on various web sources such as blogs, review websites, micro-blogging (for example, Twitter (Twitter is a trade mark of Twitter Inc.)), etc. Explicit UGC may be analyzed by finding sentiment keywords which co-occur with the topic of interest (for example, a brand name). The sentiment keywords are classified into positive and negative keywords from a lexical resource (for example, SentWordNet corpus at http://sentiwordnet.isti.cnr.it/). The sentiment analysis may return sentiment scores such as positive, negative, etc.

User information needs may be covered by current content (according to a user profile), i.e., a web page may cover the initial information need of the user, but the user may have a negative sentiment towards the actual content he finds in the web page.

Web browsing sentiment analysis is different from user profiling of the user's information needs as it analyzes the user's sentiment to the current content. For example, an offer in the web page may not be good enough, although the web page provides offers which fulfil the initial information need of the user.

### BRIEF SUMMARY

According to a first aspect of the present invention there is provided a computer-implemented method for sentiment estimation of a web browsing user performed by a computerized device using a processor, comprising: estimating for pages of a website a sentiment based on background content; receiving a path of pages browsed by a user to a current page; and estimating the user's sentiment to a current page based on the path taken to the current page and the sentiments based on the background content of the visited pages.

According to a second aspect of the present invention there is provided a computer program product for sentiment estimation of a web browsing user, the computer program product comprising: a computer readable non-transitory storage medium having computer readable program code embodied therewith, the computer readable program code comprising: computer readable program code configured to: estimate for pages of a website a sentiment based on background content; receive a path of pages browsed by a user to a current page; and estimate the user's sentiment to a current page based on the path taken to the current page and the sentiments based on the background content of the visited pages.

According to a third aspect of the present invention there is provided a system for sentiment estimation of a web browsing user, comprising: a processor; a background content sentiment estimating component for estimating for pages of a website a sentiment based on background content; a user browsing path receiver for receiving a path of pages browsed by a user to a current page; and a user sentiment estimator for estimating the user's sentiment to a current page based on the path taken to the current page and the sentiments based on the background content of the visited pages.

According to a fourth aspect of the present invention there is provided a method of providing a service to a customer over a network, the service comprising: estimating for pages of a website a sentiment based on background content; receiving a path of pages browsed by a user to a current page; and estimating the user's sentiment to a current page based on the path taken to the current page and the sentiments based on the background content of the visited pages.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a flow diagram of an embodiment of a method in accordance with the present invention;

FIGS. 2A and 2B are flow diagrams of example embodiments of aspects of the method of FIG. 1;

FIGS. 3A and 3B are block diagrams of an embodiment of a system in accordance with the present invention;

FIG. 4 is a block diagram of a computer system in which the present invention may be implemented;

FIG. 5 is a schematic diagram illustrating an aspect in accordance with the present invention; and

FIG. 6 is a schematic diagram illustrating an example accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system and computer program product are described in which a user's sentiment or opinion is predicted with respect topics in pages of a web site they browse based on their browsing patterns and based on sentiment analysis of background web traffic and/or social media towards related topics embedded within a website's owned pages. The term topic may include a product, service, subject, website, etc. Based on the sentiment estimated, the system may also enable a website to offer alternatives based on user's sentiments.

Sentiment analysis may be carried out per topic in mind A web page may be mapped to several topics, hence, given that the user's sentiment per page topic can be estimated, the total sentiment this user has towards the content of the page may be derived.

Being able to estimate or predict the sentiment of a user that browses a website can be of high value to website owners. For example, a user that is detected as being negative towards a website (for example, due to negative words being used towards the website's content, services, offers, etc.), may be offered more assistance or special offerings which may please her and improve that user's attitude towards the website. On the other hand, in the example of an ecommerce domain, a user that is detected as being positive may be offered more products related to the current product this user is positive about. This may assist in improving website's revenues.

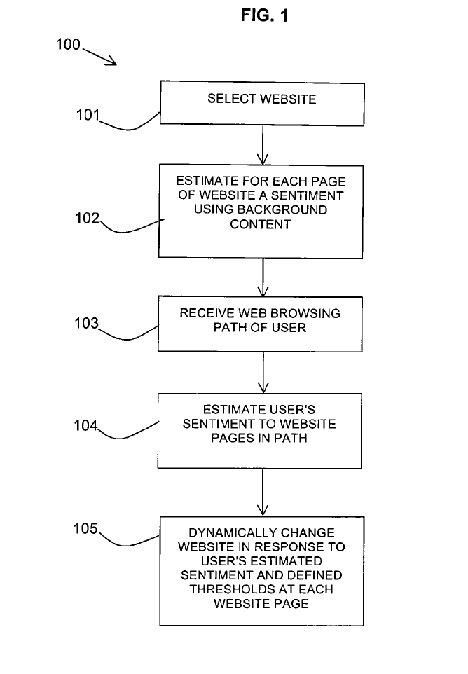

Referring to FIG. 1, a flow diagram 100 shows the described method.

A website may be selected 101 to be analyzed. The method may estimate 102, for each website page maintained by the website, its sentiment based on its topics using background content of traffic information and/or public social media data.

A web browsing path of some user may be received 103, and that user's sentiment may be estimated 104 for website pages in the path. This may be done dynamically with a user's browsing path at each page step being received and an estimate of the user's sentiment for the page being generated.

Optionally, a website may be dynamically changed 105 in response to the estimated user sentiment during a browsing session. Such dynamic changes may be based on defined thresholds of estimated sentiment being provided by the website owner.

The described method provides a way to utilize sentiment data for building a web browsing model which predicts the sentiment of a user in the website.

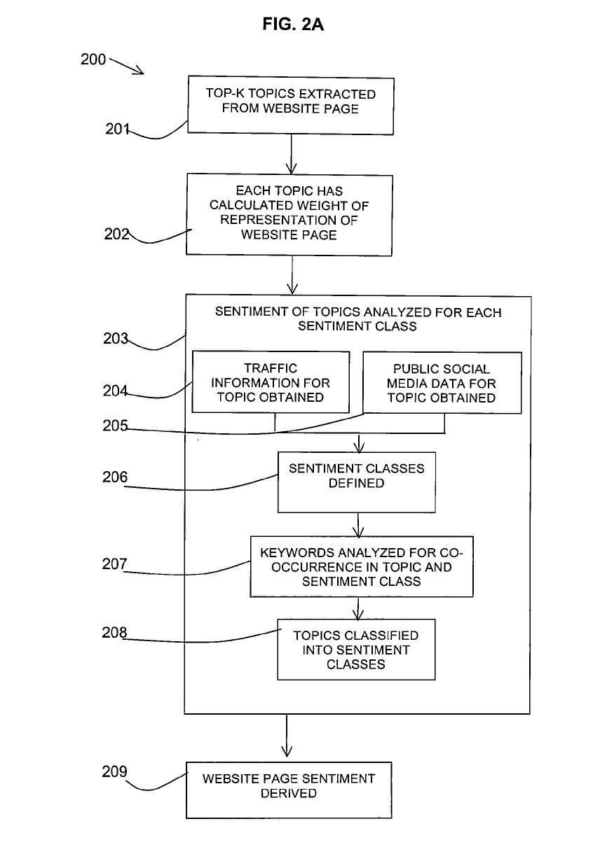

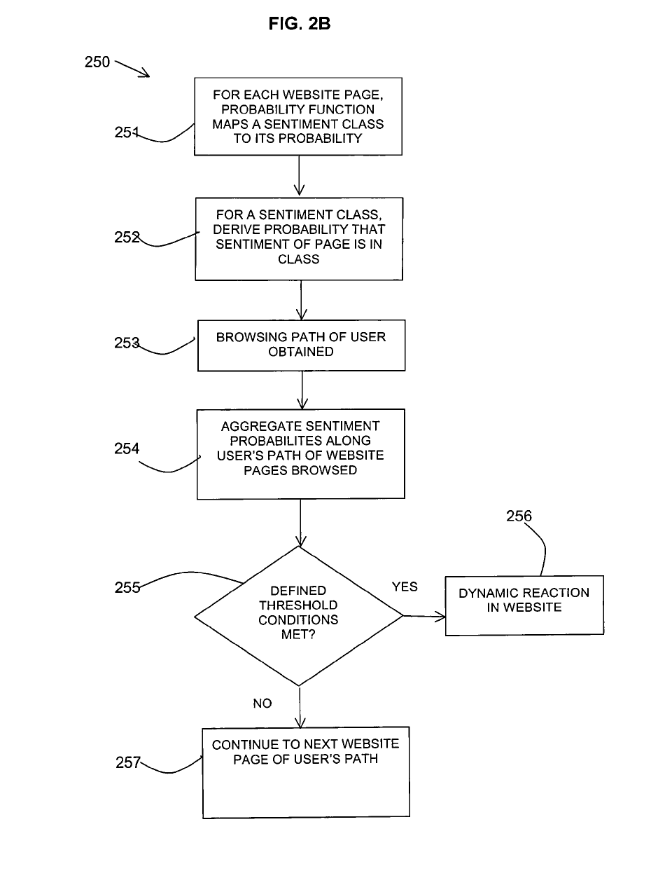

Referring to FIG. 2A, a flow diagram 200 shows an example embodiment of a method for carrying out step 102 of FIG. 1 of estimating for each website page, its sentiment using background content in the form of traffic information and/or public social media.

For a given web page, the top-k topics (or terms) may be extracted 201 that the web page relates to. This can be done using feature extraction methods (e.g., Kullback-Leibler divergence, Mutual Information, term frequency-inverse document frequency weight, etc.) or more sophisticated topic models such as Latent Dirichlet Allocation (LDA).

Given the list of top-k topics, each topic t may have a (normalized to sum of 1) weight w(t) calculated 202 which represents its representativeness of the web page.

The sentiment of the topic may be analyzed 203 for every sentiment class c (denoted S(t,c)).

The sentiment of every topic may be derived in three ways, depending on the existence of traffic information to the website.

If there is traffic information available about the web page, the content of that traffic information may be obtained 204 to derive the sentiments per page topic. Such traffic may consist of one or more of the following:
landing query texts (e.g., “I wish to cancel my subscription”, which includes the negative sentiment of “cancel” for the topic of “subscription”.);
landing pages via in-links anchor texts (e.g., <a href=“ . . . /company X”>I really hate this company X offer by this website!!</a>, in which “hate” is a negative sentiment for the topic “Company X”.); or
surrounding text (e.g., post or comment which the link is included at).

If there is no traffic information about the web page, its sentiment may be approximated by analyzing sentiments per website page topic from obtaining public social media 205 (e.g., Twitter (Twitter is a trade mark of Twitter Inc.)).

Both of the above methods may be combined to derive an overall sentiment score for the web page (e.g., using smoothing).

Sentiment classes may be defined 206. For simplicity, in this embodiment two sentiment classes are assumed, positive and negative. The extension to more sentiment classes is straightforward (e.g. positive, negative, neutral).

Given a topic, sentiments towards the topic may be derived from analyzing 207 keywords that co-occur with that topic and classifying 208 them into negative and positive keywords. The classification may be carried out using a lexical resource (for example, SentiWordNet corpus http://sentiwordnet.isti.cnr.it/).

For example, if the topic is “company X”, the following sentence “I hate company X” will assign negative sentiment to this topic, while a sentence like “Company X is the best mobile company” will be assigned a positive sentiment.

The overall page sentiment may be derived 209 as a weighted sum over the topics of the page, S(p,c)=sum w(t)*S(t,c).

Referring to FIG. 2B, a flow diagram 250 shows an example embodiment of a method for carrying out step 104 of FIG. 1 of estimating or predicting the sentiment of a user that browses the website.

For each website page p, assume there is a probability function that maps 251 a sentiment class into its probability. For sentiment class c (e.g., negative, positive, etc.), let P_{S}(p,c) denote the probability that the sentiment of page p is c. Such probability may be derived 252 as P_{S}(p,c)=S(p,c)/sum_{{c′}}S(p,c′).

The sentiment of a user that browses the website may be based on that user's browsing path and the sentiment probabilities associated with each website page.

The browsing path, b=p1->p2->p3-> . . . ->pk, of a user may be obtained 253, wherein p1, p2, p3, . . . pk are website pages. The sentiment probabilities of this user based on his browsing pattern is then estimated by aggregating (e.g. by multiplication) 254 the sentiment probabilities along his browsing path, P_{S} (u,c|b)=P_{S} (p1,c)* P_{S} (p2,c) . . . * P_{S} (pk,c).

At each step of user's u browsing, a threshold probability may be provided to be checked 255 which may define conditions for reaction from the website owner. If defined threshold conditions are not met, the method may continue 257 to estimate the sentiment probability at the next website page of the user's path as obtained in step 253. If the threshold conditions are met, a dynamic reaction may be provided 256 by the website.

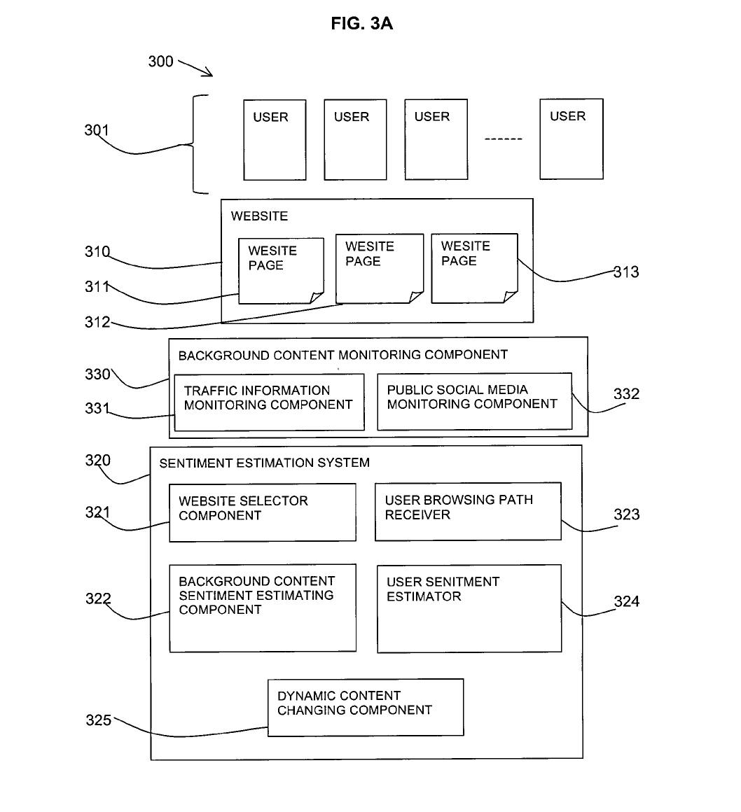

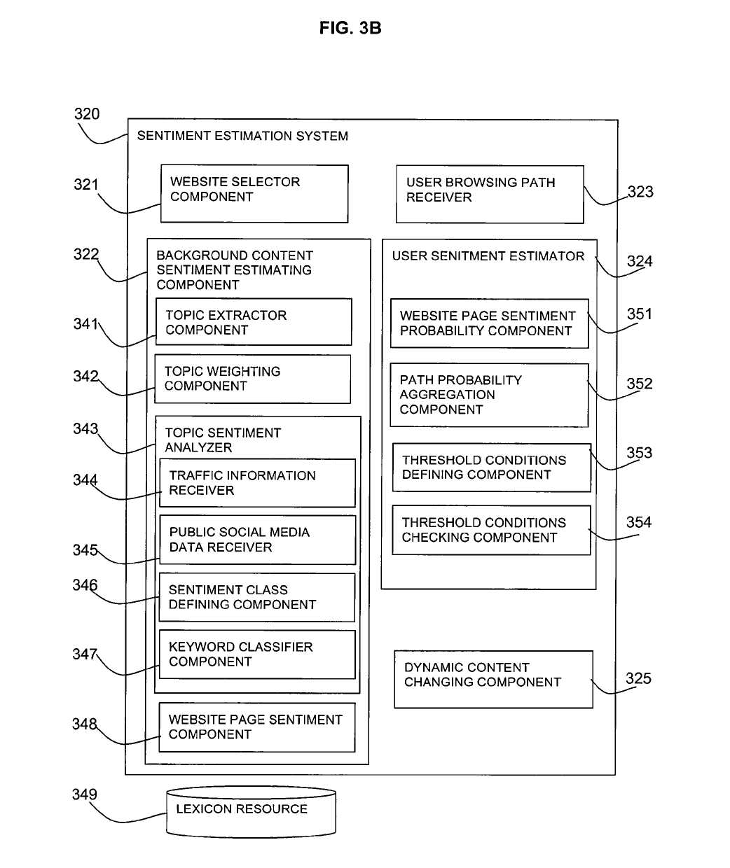

Referring to FIG. 3A, a block diagram 300 shows an example embodiment of the described system.

Users 201 may browse pages 311-313 of a website 310. Each user 201 may follow a path through the pages 311-313 following links.

A background content monitoring component 330 may be provided including one or both of a traffic information monitoring component 331 and a public social media monitoring component 332. The traffic monitoring component 331 may monitor a website page for landing query texts, in-link anchor texts, surrounding text, etc. The public social media monitoring component 332 may monitor data relating to a website page obtained from public social media sites.

A sentiment estimation system 320 may be provided for estimating a user's sentiment as he browses pages of a website.

The sentiment estimation system 320 may include a website selector component 321 for selecting a website to be monitored. A background content sentiment estimating component 322 may be provided for estimating for each page of a website a sentiment based on background content monitored by the background content monitoring component 330.

The sentiment estimation system 320 may also include a user browsing path receiver 323 for receiving a path of website pages which a user is browsing. A user sentiment estimator 324 may be provided for estimating a user's sentiment for a website page. A dynamic content changing component 325 may be provided for dynamically changing the website content in response to a user's estimated sentiment.

Further details of the sentiment estimation system 320 are shown in FIG. 3B.

The background content sentiment estimating component 322 may include a topic extractor component 341 for extracting the top topics that a website page relates to. The topic extractor component 341 may use feature extraction methods or topic models. A topic weighting component 342 may be provided for determining a normalized weight representing a topics relevance to the website page.

A topic sentiment analyzer 343 may be provided in the background content sentiment estimating component 322 for analyzing a topic according to sentiment classes which may be defined in a sentiment class defining component 346. The topic sentiment analyzer 343 may include a traffic information receiver 344 and a public social media data receiver 345 and background content data may be obtained from either or both the receivers 344, 345. A keyword classifier 347 may be provided to classify key words which co-occur in a topic and sentiment class which may refer to a lexicon resource 349. A website page sentiment component 348 may be provided in the background content sentiment estimating component 322 for deriving the overall page sentiment as a weighted sum over the topics of a page.

The user sentiment estimator 324 may include a website page sentiment probability component 351 which may derive a probability that the sentiment of a page is in a sentiment class. A path probability aggregation component 352 may be provided to determine a probability sentiment class for a page arrived at along a path browsed by a user.

The user sentiment estimator 324 may include a threshold conditions defining component 353 for defining threshold conditions which, if met, may result in a dynamic change to website content provided to the user. A threshold conditions checking component 354 may check a user's probability of a sentiment class for a website page.

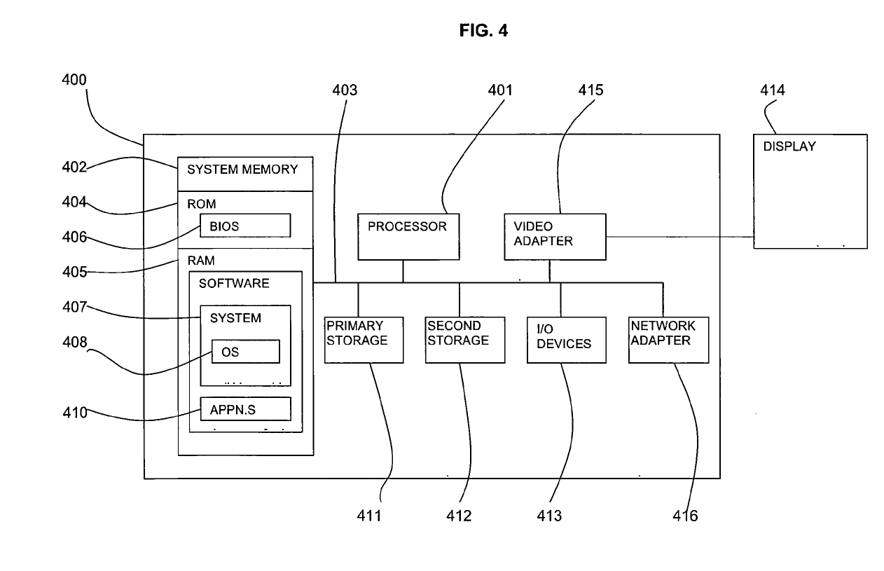

Referring to FIG. 4, an exemplary system for implementing aspects of the invention includes a data processing system 400 suitable for storing and/or executing program code including at least one processor 401 coupled directly or indirectly to memory elements through a bus system 403. The memory elements can include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 can be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

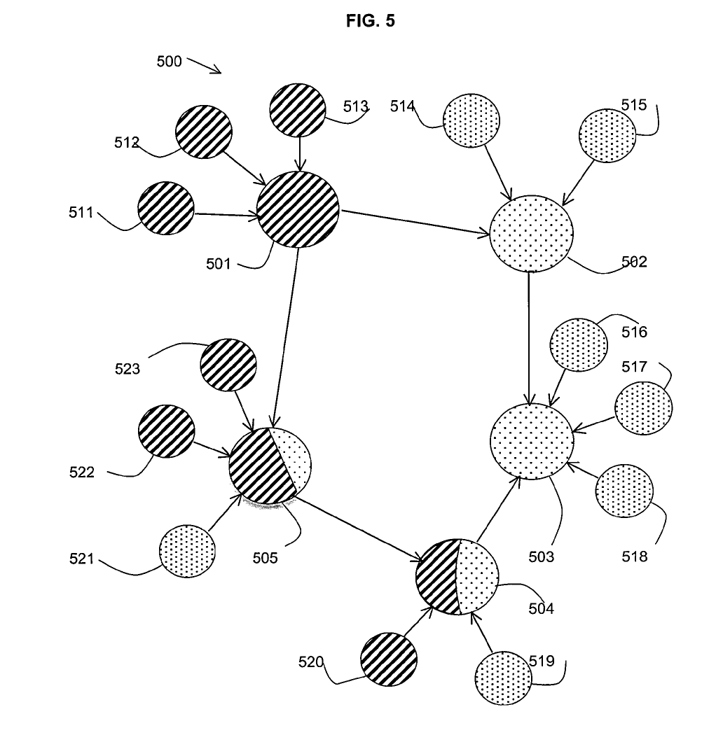

Referring to FIG. 5, a graph 500 illustrates how a website pages' sentiments are derived from traffic data based on anchor text of in-links of web pages that link to the website pages. The website pages are depicted as big circles 501-505 and the linking traffic web pages in small circles 511-523.

The small circles 511-523 representing the in-linking web pages are graded showing the analyzed sentiments for the in-linking web pages. For example, the grading may be represented by colouring such as red for negative and green for positive. In FIG. 5, red is depicted as dots and green as stripes.

The big circles 501-505 representing the website pages are then graded derived from the grading of the in-linking web pages connecting to the website pages. For example, the page represented by big circle 504 has a negative in-link and a positive in-link and is therefore graded half positive (striped) and half negative (dotted).

Based on this initial sentiment analysis per website page, the website owner may make decisions. For example, the website owner may decide to remove those pages about offers that receive very negative sentiments. As another example, the website owner may decide to add content mitigating the negative sentiment.

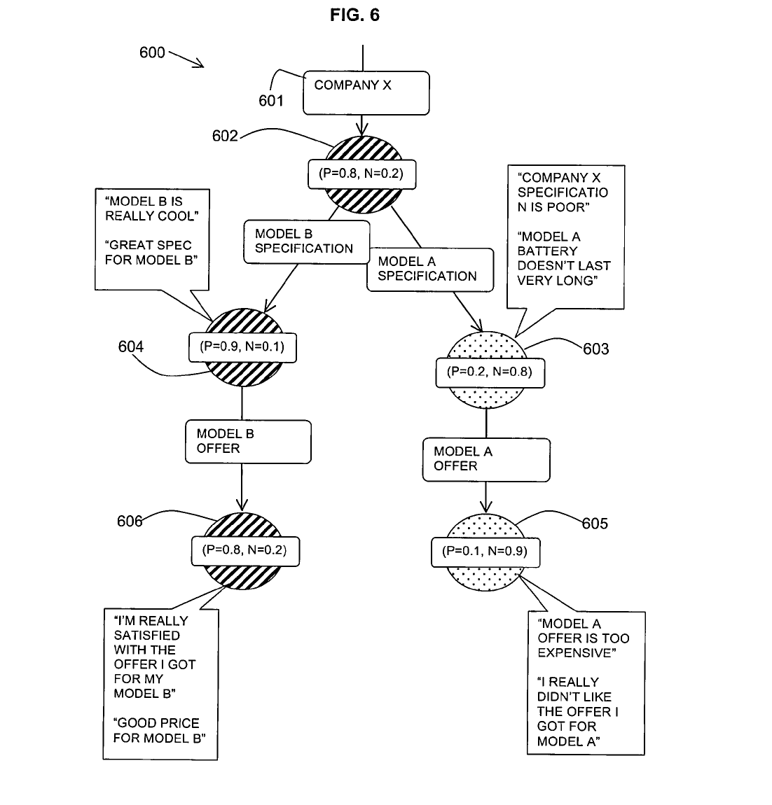

FIG. 6, further illustrates a scenario with positive and negative sentiment browsing paths to demonstrate the usage of a sentiment threshold.

A user “Alice” wishes to buy a new company X mobile phone. Searching for “company X” 601 using a search engine, Alice gets a result which leads her to a website which sells mobile phones and provides various related services.

Analyzing the topic “company X” reveals that company X has very positive sentiment with probability 0.8 for positive and only 0.2 for negative. Therefore, the model assumes that Alice has 0.8 probability to be positive about company X when reaching her landing web page 602 on company X in the website.

Reaching the first web page 602 of the website, Alice sees two links to two web pages 603, 604 which sell two different types of company X mobile phones, model A and model B.

Analyzing the sentiment of the web page 603 which describes the specification of model A has revealed that the website proposed specification receives negative sentiment with high probability of 0.8. On the other hand the web page 604 on model B specification receives a high probability of positive sentiment.

Based on the user's decision, it may be predicted whether there is a chance that her sentiment will remain positive (with probability 0.8*0.9=0.72) in the case where she browses to the model B specification web page 604 or deviate (with probability of 0.8*0.2=0.16) in the case where she browses to the model A specification web page 603.

It is assumed that the website owner has defined a threshold 0.1 on every web page to react in case of a very low positive sentiment probability.

For example, in the case where the user continues to the model A offer web page 605 her positive sentiment probability will be estimated as 0.8*0.2*0.1=0.016. This is due to very negative sentiment estimated for the website model A offers (for example, if everyone thinks that the price is too high).

In this case, the threshold set by the website owner is satisfied and the website owner might wish to improve the chance that the user will still like the offer. For example, the website owner may wish to take some action such as to offer extra earphones or battery together with the original offer and price to make the offer more attractive to such a user.

On the other hand if the user follows the relatively “positive” sentiment path and arrives at the model B offer web page 606, the positive sentiment of that user is estimated to be 0.8*0.9*0.8=0.576.

For such cases the website owner may use another threshold to push more offers related to the model B to that user. For example, the website owner may also display to the user earphones that the user may purchase separately together with the model B mobile phone.

The described method is not a mere usage of sentiment analysis for topic-based granularity, but a method for obtaining the sentiment of each node in the user model of the average user as mentioned above, and how to utilize this model for prediction.

Without such explicit signals as user generated content, a user browsing model based on average user sentiments towards the web pages (and their topics) of the website is beneficial. This model may then be utilized for predicting the user's sentiment based on her actions in the website.

A sentiment prediction system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for sentiment estimation of a web browsing user performed by a computerized device using a processor, comprising:
estimating for pages of a website a sentiment based on background content;
receiving a path of pages browsed by a user to a current page; and
estimating the user's sentiment to a current page based on the path taken to the current page and the sentiments based on the background content of the visited pages.

2. The method as claimed in claim 1, including:
dynamically changing website content provided to the user based on the user's estimated sentiment to a current page.

3. The method as claimed in claim 1, wherein estimating for pages of a website a sentiment based on background content, includes:
extracting a number of top topics from a page;
weighting the topics in relevance to the page;
analyzing the topics to classify the topics into sentiment classes; and
deriving an estimated page sentiment by combining the topics.

4. The method as claimed in claim 1, wherein background content is obtained from one or both of: traffic information to a page, and public social media relating to topics of the page.

5. The method as claimed in claim 4, wherein traffic information to a page includes one or more of the group of: landing query texts, in-link anchor texts, surrounding text.

6. The method as claimed in claim 3, including:
defining sentiment classes as one or more of the group of: a positive class, a negative class, a neutral class, other sentiment classes.

7. The method as claimed in claim 3, wherein analyzing the topics to classify the topics into sentiment classes analyses co-occurrences of keywords in a topic and sentiment class.

8. The method as claimed in claim 1, wherein estimating the user's sentiment to a current page based on the path taken to the current page and the sentiments based on the background content of the visited pages, includes:
determining a probability that the sentiment for a page is in a sentiment class;
aggregating the sentiment probabilities for pages along the user's path to the current page.

9. The method as claimed in claim 1, including:
determining if defined threshold conditions are met by an estimated user's sentiment to a current page.

10. A computer program product for sentiment estimation of a web browsing user, the computer program product comprising:
a computer readable non-transitory storage medium having computer readable program code embodied therewith, the computer readable program code comprising:
computer readable program code configured to:
estimate for pages of a website a sentiment based on background content;
receive a path of pages browsed by a user to a current page; and
estimate the user's sentiment to a current page based on the path taken to the current page and the sentiments based on the background content of the visited pages.

11. A system for sentiment estimation of a web browsing user, comprising:
a processor;
a background content sentiment estimating component for estimating for pages of a website a sentiment based on background content;
a user browsing path receiver for receiving a path of pages browsed by a user to a current page; and
a user sentiment estimator for estimating the user's sentiment to a current page based on the path taken to the current page and the sentiments based on the background content of the visited pages.

12. The system as claimed in claim 11, including:
a dynamic content changing component for dynamically changing website content provided to the user based on the user's estimated sentiment to a current page.

13. The system as claimed in claim 11, wherein the background content sentiment estimating component, includes:
a topic extractor component for extracting a number of top topics from a page;
a topic weighting component for weighting the topics in relevance to the page;
a topic sentiment analyzer for analyzing the topics to classify the topics into sentiment classes; and
a page sentiment component for deriving an estimated page sentiment by combining the topics.

14. The system as claimed in claim 11, wherein the background content sentiment estimating component includes one or both of: a traffic information receiver for receiving traffic information to a page, and a public social media data receiver for receiving public social media relating to topics of the page.

15. The system as claimed in claim 13, including:
a sentiment class defining component for defining sentiment classes as one of more of the group of: a positive class, a negative class, a neutral class, another sentiment class.

16. The system as claimed in claim 13, wherein the topic sentiment analyzer for analyzing the topics to classify the topics into sentiment classes analyzes co-occurrences of keywords in a topic and sentiment class.

17. The system as claimed in claim 11, wherein the user sentiment estimator includes:
a page sentiment probability component for determining a probability that the sentiment for a page is in a sentiment class;
a path probability aggregation component for aggregating the sentiment probabilities for pages along the user's path to the current page.

18. The system as claimed in claim 11, including:
a threshold conditions checking component for determining if defined threshold conditions are met by an estimated user's sentiment to a current page.

19. A method of providing a service to a customer over a network, the service comprising:
estimating for pages of a website a sentiment based on background content;
receiving a path of pages browsed by a user to a current page; and
estimating the user's sentiment to a current page based on the path taken to the current page and the sentiments based on the background content of the visited pages.
